(19) United States
(12) Patent Application Publication
(10) Pub. No.: US 2020/0090501 A1
(43) Pub. Date: Mar. 19, 2020

(54) ACCIDENT AVOIDANCE SYSTEM FOR PEDESTRIANS

(71) Applicant: INTERNATIONAL BUSINESS MACHINES CORPORATION, ARMONK, NY (US)

(72) Inventors: KYLE GILBERTSON, ROCHESTER, MN (US); BLAIR WYMAN, ROCHESTER, MN (US); JIM COON, ROCHESTER, MN (US); CARY M. HUETTNER, ROCHESTER, MN (US); IGAR SHEPELEV, ROCHESTER, MN (US); AARON C. EVANS, ROCHESTER, MN (US)

(21) Appl. No.: 16/135,071

(22) Filed: Sep. 19, 2018

(51) Int. Cl. G08G 1/005; G06K 9/00; H04W 4/02; G08B 7/06; G08B 21/02

(52) U.S. Cl. CPC G08G 1/005; G06K 9/00664; G08B 21/02; G08B 7/066; H04W 4/027

(57) ABSTRACT

Examples of techniques for pedestrian accident avoidance are disclosed. Aspects include receiving, by a processor from a first sensor, an indication that a user is moving and activating, by the processor, a second sensor responsive to receiving the indication. Aspects also include detecting, via the second sensor, an obstacle in a path of the user and providing an alert to the user of the obstacle.

### BACKGROUND

The present invention generally relates to accident avoidance systems, and more specifically, to accident avoidance systems for distracted or unaware pedestrians.

It is not safe for a pedestrian to walk down the street, or across the street, while looking at their smartphone or smartwatch. As the use of personal electronic devices, such as smartphones and smartwatches, continues to increase the number of accidents that pedestrians suffer due to being distracted by their smartphones is also increasing. The risk of injury to pedestrians is so high that some municipalities impose fines for texting while walking, especially through intersections.

### SUMMARY

Embodiments of the present invention are directed by a computer-implemented method for pedestrian accident avoidance. An example of the computer-implemented method includes receiving, by a processor from a first sensor, an indication that a user is moving and activating, by the processor, a second sensor responsive to receiving the indication. The method also includes detecting, via the second sensor, an obstacle in a path of the user and providing an alert to the user of the obstacle.

Embodiments of the present invention are directed by a computer program product for pedestrian accident avoidance. The computer program product being on a computer readable storage medium having program instructions embodied therewith, the program instructions executable by a processing device to cause the processing device to perform a method. The method includes receiving, by a processor from a first sensor, an indication that a user is moving and activating, by the processor, a second sensor responsive to receiving the indication. The method also includes detecting, via the second sensor, an obstacle in a path of the user and providing an alert to the user of the obstacle.

Embodiments of the present invention are directed by a system for pedestrian accident avoidance. The system includes a memory having computer readable instructions and a processing device for executing the computer readable instructions for performing a method. The method includes receiving, by a processor from a first sensor, an indication that a user is moving and activating, by the processor, a second sensor responsive to receiving the indication. The method also includes detecting, via the second sensor, an obstacle in a path of the user and providing an alert to the user of the obstacle.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a user device for implementing the described techniques according to one or more embodiments described herein;

FIG. 2 depicts a flow diagram of a method for pedestrian accident avoidance according to one or more embodiments described herein;

FIG. 3 depicts a flow diagram of another method for pedestrian accident avoidance according to one or more embodiments described herein;

FIG. 4 depicts illustrations of pedestrians using user devices for accident avoidance according to one or more embodiments described herein;

FIG. 5 depicts an illustration of a pedestrian using a user device for accident avoidance according to one or more embodiments described herein; and

FIG. 6 depicts an illustration of a display of a user device for pedestrian accident avoidance according to one or more embodiments described herein.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of the aspects of the invention, one or more embodiments of the invention address the above-described shortcomings of the prior art by providing alerts to pedestrians of obstacles that are in their path. The technical solutions provided herein represent improvements to handheld user devices. For example, the user device is improved by incorporating inertial sensors that are used to determine a speed of a user and to responsively control lidar sensors in the user device to detect the presence of obstacles in the user's path. Once an obstacle is detected, the user device will warn the user of the upcoming risk in one of various manners, which include, but are not limited to, haptic feedback, visual clues, banner messages, and/or warning sounds.

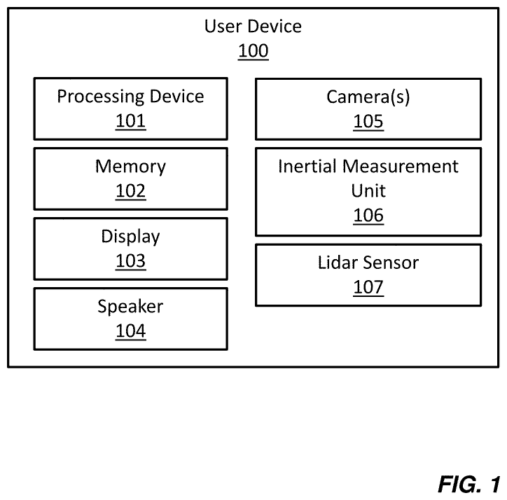

Turning now to a more detailed description of aspects of the present invention, FIG. 1 depicts a block diagram of a user device 100 for pedestrian accident avoidance according to one or more embodiments described herein. The user device 100 includes a processing device 101, a memory 102, a display 103, a speaker 104, one or more cameras 105, an inertial measurement unit 106 and a lidar sensor 107. In exemplary embodiments, the user device 100 is a smartphone, tablet, or other handheld electronic device. In exemplary embodiments, processing device 101 can include any suitable processing device, such as a reduced instruction set computer (RISC) microprocessor, application specific integrated circuits (ASICs), application specific special processors (ASSPs), field programmable gate arrays (FPGAs), or the like. The processing device 101 is coupled to memory 102, which can include both a volatile and non-volatile storage. In one embodiment, the display 103 is a touchscreen display that can be used to provide visual alerts to the user. The one or more cameras 105 can be disposed on various surfaces of the user device 100. For example, the one or more cameras 105 include a front facing camera that is able to detect whether a user is looking at the display 103 of the user device 100. Likewise, the one or more cameras 105 include a rear-facing camera that is able to capture an image of a detected obstacle in the path of the user.

In one embodiment, the inertial measurement unit (IMU) 106 is an electronic sensor disposed within the user device 100 that measures the specific force, angular rate, and optionally the magnetic field surrounding the user device 100. In one embodiment, the inertial measurement unit 106 includes a combination of accelerometers, gyroscopes, and magnetometers. The inertial measurement unit 106 is configured to detect the direction and speed of the user in possession of the user device 100 when moving, i.e., walking or running. As a result, the user device 100 will be able to better predict upcoming risks by directing its lidar sensors in the corresponding direction and distance to detect obstacles and give the user sufficient time to react to a warning.

In one embodiment, the lidar sensor 107 measures the distance from the user device 100 to various objects by illuminating the objects with pulsed laser light and measuring the reflected pulses. Differences in laser return times and wavelengths are used to make three-dimensional models of the objects. The lidar sensor 107 has an aperture that is adjustable to control the size and direction of the area scanned by the lidar sensor 107, which adjusts the field of view of the lidar sensor 107. In exemplary embodiments, the processing device 101 monitors the output of the inertial measurement unit 106 and responsively adjusts the field of view of the lidar sensor 107. In one embodiment, as the speed of the user increases, the size of the field of view of the lidar sensor 107 is increased. By selectively focusing the lidar sensor 107 towards the most likely user path, based on the IMU 106 data, the processing device 101 avoids wasting feature-extraction analysis on irrelevant surfaces (i.e. behind the user).

In exemplary embodiments, the processing device 101 performs feature-extraction analysis on a point cloud of high-resolution distance samples (those from a directed focusable lidar sensor 107) to model parts of the upcoming surface it has been dynamically directed/focused to detect. In real time, the processing device 101 identifies the significant variations in distances that signal impending pitfalls, stumbling blocks, or otherwise uncertain terrain. Unique challenges, such as floors covered with marbles or rocks leading across a stream, could be too difficult to sense accurately. In these cases, the processing device 101 will warn the user, and potentially even disable the distracting device's visual interface until the ground becomes more certain and the disclosed device can return to proper operation.

In one embodiment, upon detecting an obstacle or hole in the path of the user, the processing device 101 could capture and present an image or outline of the obstacle/hole to the “top” of the view stack on the display 103, overlaying any other visual data on the screen. Another embodiment includes providing an on-screen visual warning when detecting that the user's eyes had been fixed on the display 103 for longer than a customizable interval while the user is walking, regardless of impending pathway risks. If the user's eyes are focused on the display 103 past that threshold, the user's visual interface on the distracting device could be suspended by a modal dialog requiring their acknowledgment to continue.

The various components, modules, method, etc. described herein can be implemented as instructions stored on a computer-readable storage medium, as hardware modules, as special-purpose hardware or as some combination or combinations of these. According to aspects of the present disclosure, the method(s) described herein can be a combination of hardware and programming. The programming can be processor executable instructions stored on a tangible memory, and the hardware can include the processing device 101 for executing those instructions. Thus a memory 102 can store program instructions that when executed by the processing device 101 implements the methods described herein. Other methods can also be utilized to include other features and functionality described in other examples herein.

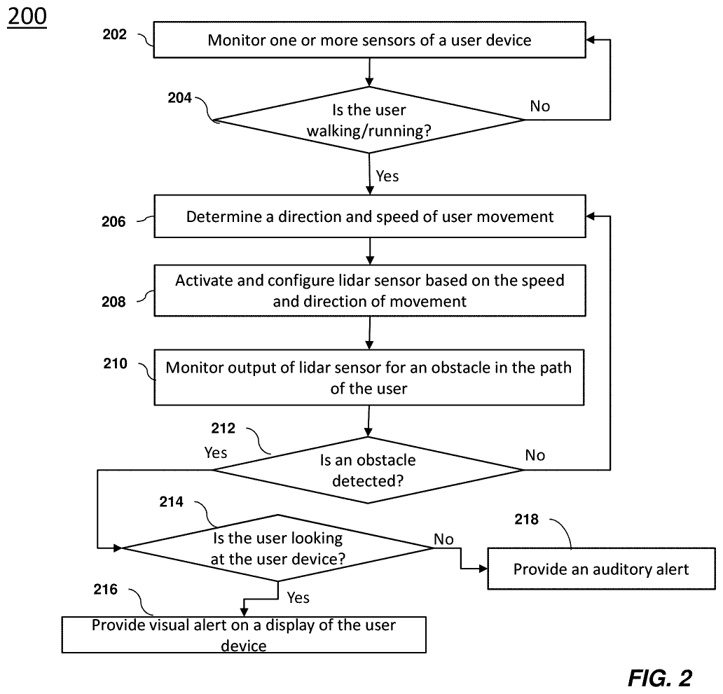

Referring now to FIG. 2, a flow diagram of a method 200 for preventing a pedestrian accident using an electronic device according to one or more embodiments described herein is shown. The method 200 can be performed using any suitable processing system or user device, such as the user device 100 and/or other suitable systems and/or devices. As shown at block 202, the method 200 includes monitoring one or more sensors of a user device. In one embodiment, the user device is a smartphone and the one or more sensors include an inertial measurement sensor. Next, as shown at decision block 204, the method 200 includes determining if the user of the user device is walking or running. If the user is walking or running, the method 200 proceeds to block 206 and determines a direction and speed of the movement of the user. If the user is not walking or running, the method 200 returns to block 202.

Next, as shown at block 208, the method 200 includes activating and configuring a lidar sensor based on the speed and direction of the user movement. In exemplary embodiments, the lidar sensor has an adjustable field of view and as the speed to the user increases the size of the field of view of the lidar sensor is increased. Next, as shown at block 210, the method 200 includes monitoring the output of the lidar sensor for an obstacle in the path of the user. At decision block 212, the method 200 determines if an obstacle is in the path of the user. If an obstacle is detected, the method 200 proceeds to decision block 214 and determines if a user is looking at the display of the user device. If an obstacle is not detected at block 212, the method 200 returns to block 206 and updates the speed and direction of the user.

In one embodiment, the determination of whether a user is looking at the display of the user device is made based on an analysis of images captured by a front-facing camera on the user device. If at block 214, it is determined that the user is looking at the display of the user device, the method 200 includes providing a visual alert on the display of the user device, as shown at block 216. Otherwise, as shown at block 218, the method includes providing an auditory alert to the user. In one embodiment, the visual alert can include an indication of the type of obstacle detected. In one embodiment, the alert can include an indication of the distance between the user and the obstacle detected.

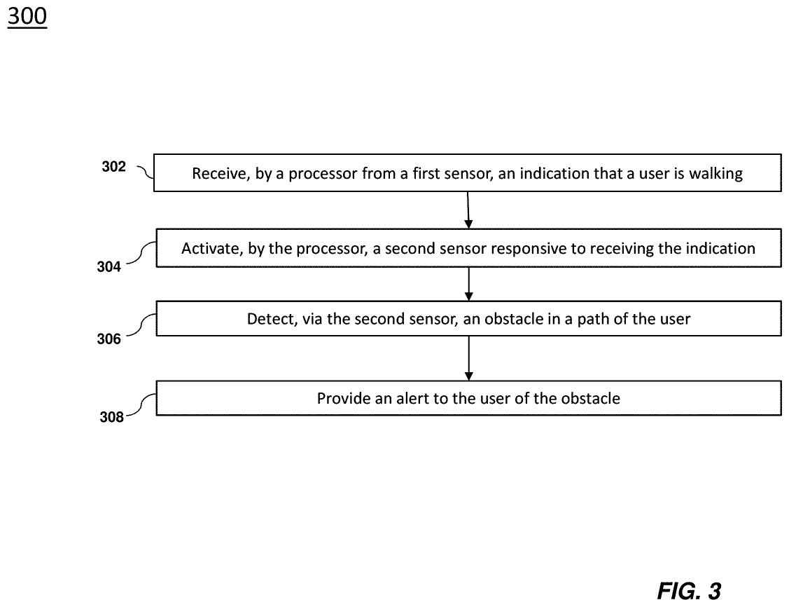

Referring now to FIG. 3, a flow diagram of a method 300 for pedestrian accident avoidance according to one or more embodiments described herein is shown. The method 300 can be performed using any suitable processing system or user device, such as the user device 100 and/or other suitable systems and/or devices. As shown at block 302, the method 300 includes receiving, by a processor from a first sensor, an indication that a user is walking. In exemplary embodiments, the first sensor is an inertial measurement unit. In one embodiment, the indication includes a direction and a speed that the user is walking. Next, as shown at block 304, the method 300 includes activating, by the processor, a second sensor responsive to receiving the indication. In one embodiment, the second sensor includes an adjustable field of view and wherein activating the second sensor includes setting the adjustable field of view based on the direction and the speed that the user is walking.

Next, as shown at block 306, the method 300 includes detecting, via the second sensor, an obstacle in a path of the user. In one embodiment, the second sensor is a lidar sensor and the obstacle includes one or more of an uneven ground surface in the path of the user and an object in the path of the user. The method 300 also includes providing an alert to the user of the obstacle, as shown at block 308. In exemplary embodiments, the alert provided to the user is one of a tactile, haptic, auditory and visual alert. In one embodiment, the alert is provided to the user via a display of a smartphone based on a determination that the user is looking at the smartphone. In another embodiment, the alert is provided via a smartwatch based on a determination that the user is not looking at the smartphone. In another embodiment the obstacle detection and warning system can be turned on permanently for users with visual impairments who might not be using their device, but want the obstacle warnings

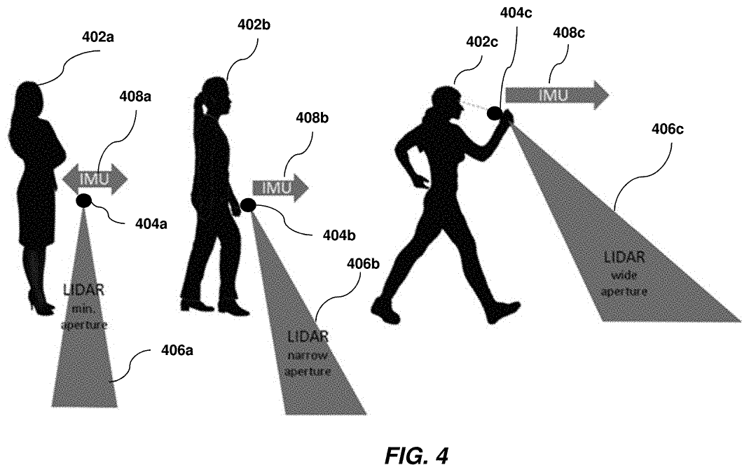

Referring now to FIG. 4, illustrations of pedestrians 402 using a user device 404 for pedestrian accident avoidance according to one or more embodiments are shown. Pedestrians 402a, 402b, 402c having user devices 404a, 404b, 404c are shown. Pedestrian 402a is shown not moving in either direction, as illustrated by the IMU 408a, accordingly, the lidar sensor is shown having its minimum aperture 406a. In another embodiment, when the pedestrian is not moving, the lidar sensor can be deactivated. Pedestrian 402b is shown moving slowly in a first direction, as illustrated by the IMU 408b, accordingly, the lidar sensor is shown having a narrow aperture 406b. Pedestrian 402c is shown moving quickly in a first direction, as illustrated by the IMU 408c, accordingly, the lidar sensor is shown having a wide aperture 406c.

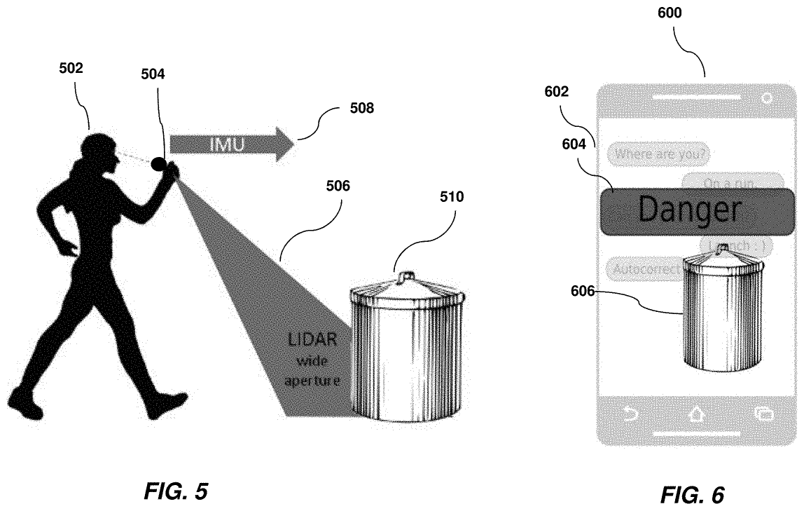

Referring now to FIG. 5, an illustration of a pedestrian 502 using a user device 504 for pedestrian accident avoidance according to one or more embodiments. As illustrated, the IMU 508 indicates that the user is moving quickly in a first direction and accordingly, the lidar sensor is shown having a wide aperture 406, which includes an obstacle 510 in its field of view. Upon detecting the obstacle 510, the user device 504 is configured to provide an alert to the pedestrian 502 to warn them of the upcoming obstacle. In one embodiment, the alert can be provided to the pedestrian via a display of the user device 504, such as shown in FIG. 6.

Referring now to FIG. 6 an illustration of a display 602 of a user device 600 for pedestrian accident avoidance according to one or more embodiments is shown. Upon detecting an obstacle, the user device 600 updates the display 602 to show an alert 604 and optionally an image 606 of the obstacle. In one embodiment, the image 606 of the obstacle is a three dimensional model, picture, or other representation of the obstacle created by the data received from the lidar sensor. In another embodiment, the image 606 of the obstacle is a picture of the image captured by a camera of the user device 600.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A method for pedestrian accident avoidance, the method comprising:
receiving, by a processor from a first sensor, an indication that a user is moving, wherein the indication includes a direction and a speed that the user is moving;
activating, by the processor, a second sensor responsive to receiving the indication, wherein the second sensor includes an adjustable field of view and wherein activating the second sensor includes setting the adjustable field of view based on the direction and the speed that the user is moving;
detecting, via the second sensor, an obstacle in a path of the user; and
providing an alert to the user of the obstacle,
wherein a field of view of the second sensor is an area covered by the second sensor and wherein setting the adjustable field of view includes adjusting an aperture of the second sensor to control a size and a direction of the area scanned by the second sensor.

2. (canceled)

3. (canceled)

4. The method of claim 1, wherein the obstacle includes one or more of an uneven ground surface in the path of the user and an object in the path of the user.

5. The method of claim 1, wherein the alert provided to the user is one of a tactile, haptic, auditory and visual alert.

6. The method of claim 5, wherein the alert is provided to the user via a smartphone based on determination that the user is looking at the smartphone and via a smartwatch based on determination that the user is not looking at the smartphone.

7. The method of claim 1, wherein the first sensor is an inertial measurement unit disposed in a smartphone of the user and wherein the second sensor is a lidar sensor disposed in the smartphone of the user.

8. A user device for pedestrian accident avoidance comprising:
a memory comprising computer readable instructions; and
a processing device for executing the computer readable instructions for performing a method for enhanced teleconferencing, the method comprising:
receiving, by a processor from a first sensor, an indication that a user is moving, wherein the indication includes a direction and a speed that the user is moving;
activating, by the processor, a second sensor responsive to receiving the indication, wherein the second sensor includes an adjustable field of view and wherein activating the second sensor includes setting the adjustable field of view based on the direction and the speed that the user is moving;
detecting, via the second sensor, an obstacle in a path of the user; and
providing an alert to the user of the obstacle,
wherein a field of view of the second sensor is an area covered by the second sensor and wherein setting the adjustable field of view includes adjusting an aperture of the second sensor to control a size and a direction of the area scanned by the second sensor.

9. (canceled)

10. (canceled)

11. The user device of claim 8, wherein the obstacle includes one or more of an uneven ground surface in the path of the user and an object in the path of the user.

12. The user device of claim 8, wherein the alert provided to the user is one of a tactile, haptic, auditory and visual alert.

13. The user device of claim 12, wherein the alert is provided to the user via a display of the user device based on determination that the user is looking at the user device and via a smartwatch based on determination that the user is not looking at the user device.

14. The user device of claim 8, wherein the first sensor is an inertial measurement unit disposed in the user device of the user and wherein the second sensor is a lidar sensor disposed in the user device of the user.

15. A computer program product comprising:
a non-transitory computer readable storage medium having program instructions embodied therewith, the program instructions executable by a processing device to cause the processing device to perform a method for enhanced teleconferencing, the method comprising:
receiving, by a processor from a first sensor, an indication that a user is moving, wherein the indication includes a direction and a speed that the user is moving;
activating, by the processor, a second sensor responsive to receiving the indication, wherein the second sensor includes an adjustable field of view and wherein activating the second sensor includes setting the adjustable field of view based on the direction and the speed that the user is moving;
detecting, via the second sensor, an obstacle in a path of the user; and
providing an alert to the user of the obstacle,
wherein a field of view of the second sensor is an area covered by the second sensor and wherein setting the adjustable field of view includes adjusting an aperture of the second sensor to control a size and a direction of the area scanned by the second sensor.

16. (canceled)

17. (canceled)

18. The computer program product of claim 15, wherein the obstacle includes one or more of an uneven ground surface in the path of the user and an object in the path of the user.

19. The computer program product of claim 15, wherein the alert provided to the user is one of a tactile, haptic, auditory and visual alert.

20. The computer program product of claim 19, wherein the alert is provided to the user via a display of a user device based on determination that the user is looking at the user device and via a smartwatch based on determination that the user is not looking at the user device.
